(19) United States
(12) Patent Application Publication
(10) Pub. No.: US 2021/0117160 A1
(43) Pub. Date: Apr. 22, 2021

(54) GAMING SYSTEM

(71) Applicant: TCS John Huxley Europe Limited, Stoke-On-Trent (GB)

(72) Inventor: Andrew Michael Saunders, London (GB)

(21) Appl. No.: 17/253,002

(22) PCT Filed: Jun. 18, 2019
(86) PCT No.: PCT/GB2019/051697

§ 371 Date: Dec. 16, 2020

(30) Foreign Application Priority Data
Jun. 29, 2018 (GB) 1810767.2

(51) Int. Cl. G06F 7/58; G07F 17/32

(52) U.S. Cl. CPC G06F 7/588; G07F 17/3269; G07F 17/3244; G07F 17/3209; G07F 17/3213

(57) ABSTRACT

A gaming system is provided to maximise the number of betting opportunities in a set period. The gaming system comprises, at least two physical random number generators each having an operative period comprising an available period and an unavailable period; a selecting member arranged to select one physical random number generator during an available period of said physical random number generator and further arranged to deselect said physical random number generator during an unavailable period of said physical random number generator; wherein the gaming system further comprises abetting member arranged to accept betting information from a user for the selected physical random number generator; wherein one physical random number generator is selected at any one time. The aim of the gaming system of the present invention is to provide the maximum number of betting opportunities in a given time period, in order to increase player satisfaction and enhance the overall consumer experience. The number of opportunities can be customised according to the specific gambling regulations of a region, and wherein concurrent bets by a single user across multiple random number generators is prevented.

### FIELD OF THE INVENTION

The present invention relates to electronic gaming systems, particularly to electronic gaming systems for use in casinos.

### BACKGROUND TO THE INVENTION

Public policy in many regions around the world limits the number of bets permitted in a given time period, particularly in relation to live events and physical gambling opportunities such as roulette wheels.

Currently available sources of gambling opportunities include gaming systems within a casino environment, such as roulette for example, wherein some form of physical random number generator is used to define at least one win condition. Such games generally include an operator, or a dealer, the role of whom is often to control the pace of a particular game and to maximise the number of betting opportunities provided to a player in a given time period according to local gambling regulations. This provides increased opportunity for player reward and therefore improved player enjoyment and enhanced overall player experience.

While it is possible to train said operators or dealers to reduce the length of time spent, for instance dealing or shuffling, during a particular game, and therefore increase the number of gambling opportunities per given time period, these human-driven systems can be inherently incapable of maximising the number of gambling opportunities per given time period, and therefore player excitement, to the full potential.

Gaming systems in a casino environment increasingly include some form of automated feature, often for the purpose of improved efficiency and removal of human error. These automations may be in the sorting of casino chips and in data tracking, among others. Such automations and data tracking methods can be used to identify bottlenecks in a gaming system and may be used to train and optimise said systems to reduce the time spent during the length of a betting opportunity. However, these systems still do not completely maximise the number of betting opportunities per given time period.

It is therefore desirable to maximise opportunity for reward and enjoyment for a player by maximising the number of possible betting opportunities in a given time period, customised according to the specific gambling regulations of the region. Preferably the maximum number of betting opportunities per hour can be adjusted in order to accommodate any changes that are subsequently made to gambling regulations.

### SUMMARY OF THE INVENTION

In accordance with a first aspect of the present invention, there is provided a gaming system comprising, at least two physical random number generators each having an operative period comprising an available period and an unavailable period; a selecting member arranged to select one physical random number generator during an available period of said physical random number generator and further arranged to deselect said physical random number generator during an unavailable period of said physical random number generator; wherein the gaming system further comprises a betting member arranged to accept betting information from a user for the selected physical random number generator; wherein one physical random number generator is selected at any one time.

In the context of the present invention, the term “gaming” will be understood by the skilled addressee to mean “gambling”.

The random number generators of the present invention are physical, with the random number generation constituting a live event during a perceivable operative period—as opposed to being software-derived, wherein the generation of a random number may be considered to be instantaneous. The operative period of each random number generator, which may optionally be a roulette wheel, has an available period and an unavailable period. Preferably the available period comprises a period optimised for accepting betting information for said physical random number generators. The selecting member is arranged to select a physical random number generator during its available period, providing a selected physical random number generator, preferably on which bets can be placed by a user by submitting betting information to the betting member. There can be only one selected physical random number generator at any one time and as such bets from a single individual can only be placed on a single physical random number generator at any one time. Following the available period and during the unavailable period of said selected physical random number generator, the selecting member is arranged to deselect said selected physical random number generator and is preferably able to select a new physical random number generator during the available period of said new physical random number generator.

Preferably a random number is generated by said physical random number generators during said available period, wherein said random number defines a win condition. More preferably the available period comprises an exit period during which any of said betting information accepted from a user matching said win condition results in a win event. Still more preferably said win event comprises the transfer of a prize to said user. Most preferably said prize comprises currency.

In order to minimise the likelihood of concurrent bets on multiple physical random number generators for a single user, the available period of physical random number generators of the present invention preferably comprises the generation of a random number and the defining of a win condition. Betting information from a user matching said win condition preferably results in the transfer of a prize in the form of currency to said user during said available period and as such said selected physical random number generator is preferably not deselected until an exit period has completed. Therefore, preferably a new selected physical random number generator in an available period on which betting information might be submitted is not selected by the selecting member until all current betting on the selected physical random number generator has ceased. This preferably provides a system wherein no concurrent bets on multiple physical random number generators by a single user are possible.

In most countries around the world, depending upon the type of game being played, gambling regulations restrict the number of bets per hour, and in many cases prohibit concurrent bets on multiple active tables. As such, live events on which betting can take place, such as, for example, the spin of a roulette wheel, are only permitted to occur a specific maximum number of times in one hour. Using the present invention, the minimisation of time between the availability of betting on live events occurring enables the user to minimise time spent waiting for the same source of betting opportunities to once again be made available for betting, or time spent moving to another source of betting opportunities and waiting for said source to be made available for betting. As such the user is allowed to minimise the waiting time, and maximise the number of betting opportunities in a time period without contravening local gambling regulations.

Preferably the unavailable period immediately follows the available period. More preferably the selecting member is arranged to deselect said selected physical random number at the start of the unavailable period. Most preferably the selecting member is arranged to select one new physical random number generator during an available period of said new physical random number generator immediately following the deselecting of the previous selected random number generator.

The immediate deselecting of a selected physical random number generator following its available period, and the selecting of a new physical random number generator during its available period preferably minimises the time interval between betting opportunities for a user. This preferably allows a user to maximise their number of betting opportunities in a given time period without permitting concurrent bets on multiple physical random number generators for a single user.

Preferably the gaming system further comprises a display member, the display member being arranged to display an image of at least one of said physical random number generators. More preferably the display member is arranged to display an image of all of said physical random number generators. Still more preferably the display member is further arranged to indicate the selected physical random number generator to a user. Still more preferably the display member is arranged to display an image of only the selected physical random number generator. Still more preferably said image is provided by a camera. Most preferably said image comprises real-time video.

Preferably the betting member comprises one selected from the range: a gaming surface; a gaming table; a betting slip; a manual input device; a touch screen.

Preferably the betting member is arranged to provide a view of and access to all of the available betting options for said selected physical random number generator to a user.

Preferably at least one of the physical random number generators is located remotely to the betting member. Still more preferably all of the physical random number generators are located remotely to the betting member.

In a preferable embodiment of the present invention, the number of physical random number generators is greater than two. In further preferable embodiments, said physical random number generators may be at varying proximities to the betting member. In accordance with preferable embodiments, the number of physical random number generators can be adjusted, to add or remove physical random number generators as they are installed or decommissioned. Preferably the betting member is remote to the physical random number generators.

Preferably at least one of the physical random number generators, the selecting member, the betting member are in digital communication with a server.

Preferably the gaming system permits the accepting of betting information from a user for only one physical random number generator at any one time.

The operative period, the available period and the unavailable period preferably all have a start time and an end time defining a length.

Preferably the start time of any of: said operative period; said available period; said unavailable period; may be adjusted. Preferably the length of any of: said operative period; said available period; said unavailable period; may be adjusted.

In order to increase or decrease the number of betting opportunities in a given time period, the start time and/or length of one of the operative period, the available period or the unavailable period of one of the physical random number generators may preferably be adjusted. The preferable adjustment feature might be used for example to adhere to local gambling regulations or to modify the present system in order to accommodate changing local gambling regulations.

Preferably the gaming system comprises a plurality of betting members. Preferably each betting member accommodates at least one user. In some embodiments, a betting member may preferably accommodate a plurality of users.

Preferably the at least two random number generators are selected from the range: roulette wheel; dice shaker; dice spinner; number wheel; money wheel; sic bo; cards; electronic card shoe; manual card shoe; bingo machine; lottery machine. Still more preferably at least one of said random number generators are automated. A number of different random number generators are currently available, such as those hereinbefore described. The system of the present invention is preferably forward-compatible with future iterations of random number generators where these may be applicable to the present system.

Preferably the betting member comprises a memory arranged to store previously accepted betting information, and further provides a user with an opportunity to submit said previously accepted betting information.

Preferably, the betting member may be used to access previous betting information from the memory unit, preferably for the purpose of re-inputting the previous betting information during a subsequent betting period and preferably further minimise time spent re-entering favoured betting information. In order to enable a user to maximise their number of betting opportunities in a given time period, it would be preferable for a user to duplicate previously submitted betting information in order to avoid the time required to re-enter the same information time and time again. A more preferable feature would be to allow a user to duplicate previously made bets across subsequent selected physical random number generators, when said physical random number generators become available for betting, and so that no concurrent betting takes place. In duplicating bets across different physical random number generators, the user may be allowed to further minimise time spent re-entering the same betting information as has already been entered.

In accordance with a second aspect of the present invention, a method of maximising the number of betting opportunities in a time period is provided, the method comprising the steps of:
a) providing at least two physical random number generators arranged to generate a random number to define a win condition, the physical random number generators having an operative period comprising an available period and an unavailable period;
b) providing a betting member arranged to accept betting information from a user;
c) selecting one physical random number generator from said at least two physical random number generators, said selected physical random number generator being in the available period of said physical random number generator when selected;
d) accepting betting information on said selected physical random number generator;
e) deselecting said selected physical random number generator and immediately repeating step c).

Preferably, the deselecting of the selected physical random number generator step e) occurs immediately following the available period of said selected physical random number generator. More preferably, between step d) and step e), said selected physical random number generator generates a random number defining a win condition. Still more preferably, immediately following the defining of a win condition, betting information matching the win condition results in a win event. Still more preferably, the win event comprises the transfer of a prize to a user. Most preferably said prize comprises currency.

### DETAILED DESCRIPTION

Specific embodiments will now be described by way of example only, and with reference to the accompanying drawings, in which:

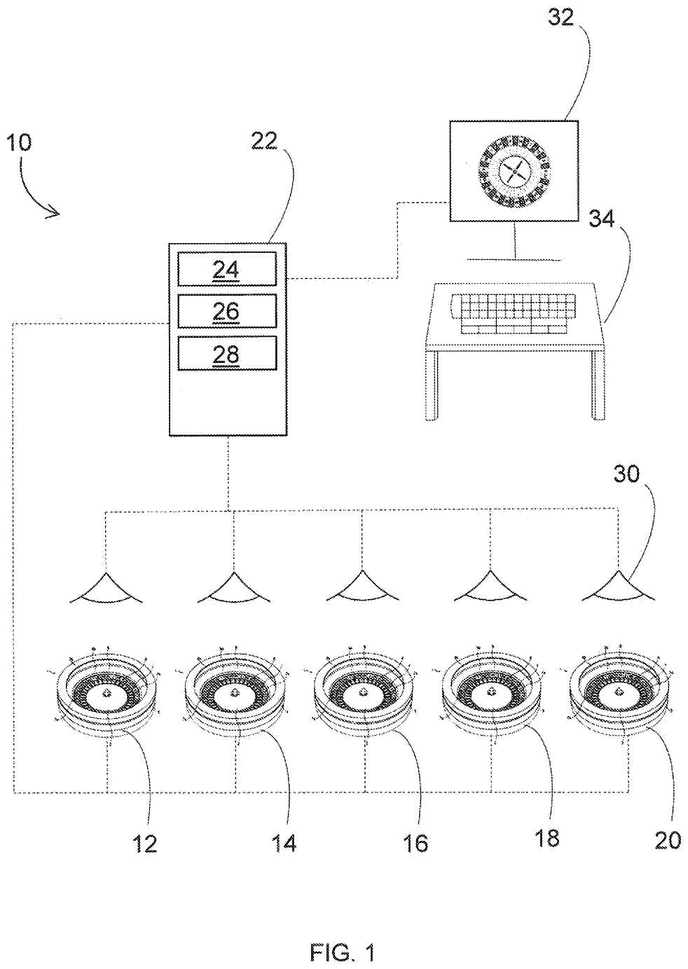

FIG. 1 is a schematic view of a system according to the first aspect of the present invention;

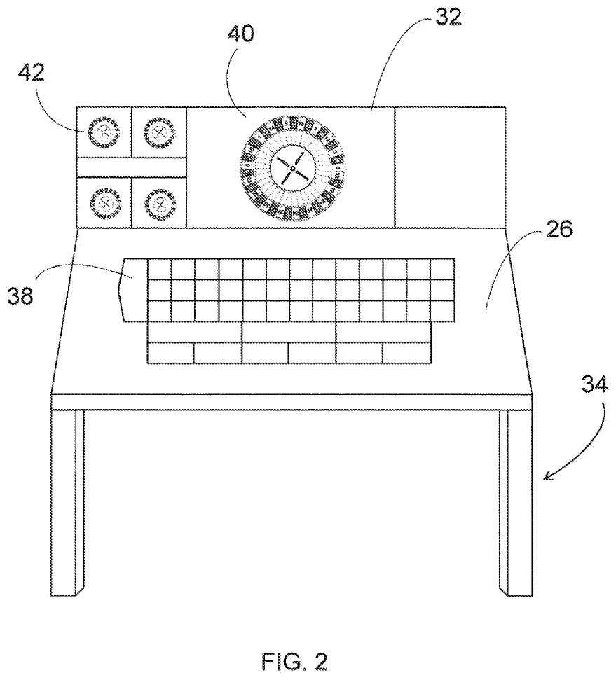

FIG. 2 is a partial view of a system according to FIG. 1;

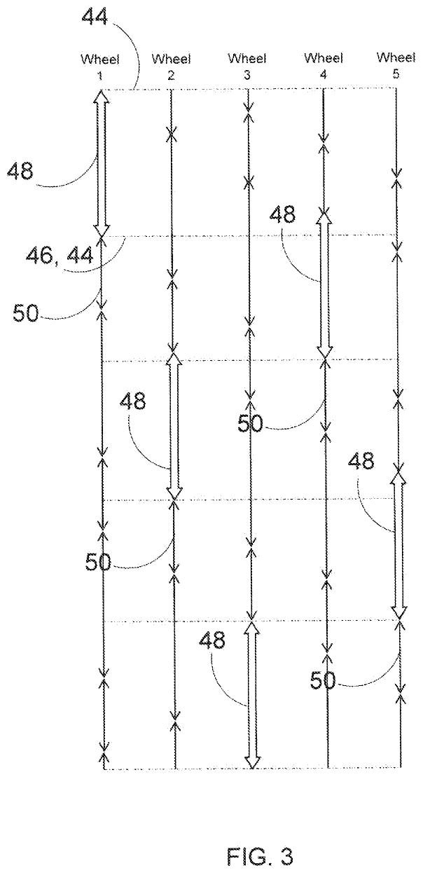

FIG. 3 is a time-lapse diagram of a method according to the second aspect of the present invention performed by a system according to FIG. 1; and

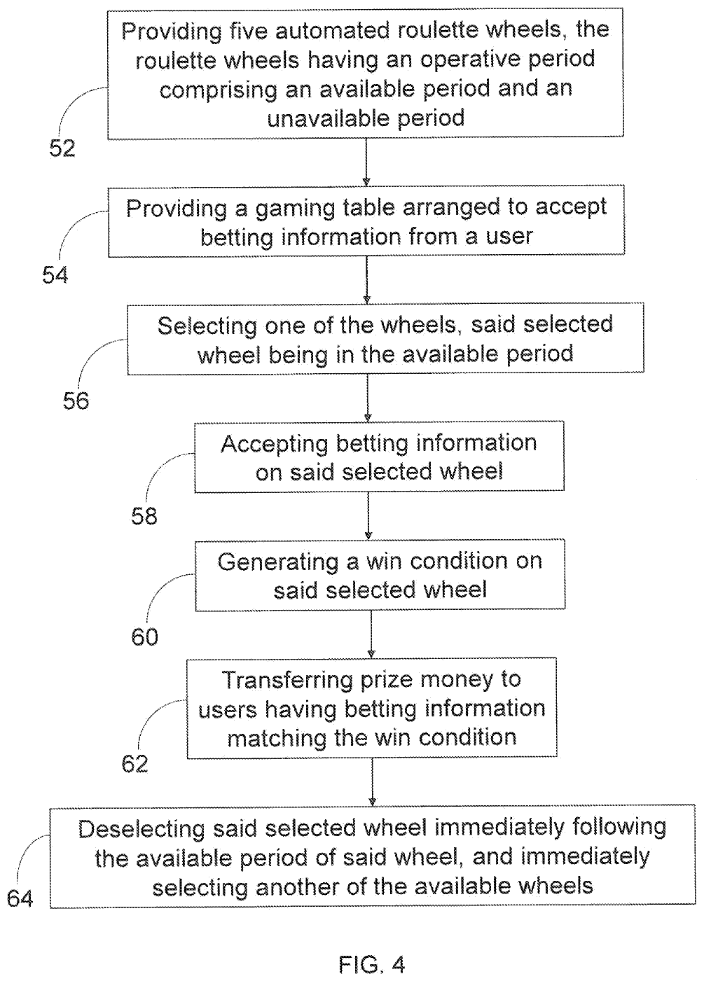

FIG. 4 is a flow diagram representing an example embodiment of a method according to the second aspect of the present invention.

With reference to FIG. 1, there is provided a system 10 according to the first aspect of the present invention, the system 10 comprising a first 12, second 14, third 16, fourth 18, and fifth 20 automated roulette wheels, said first 12, second 14, third 16, fourth 18, and fifth 20 automated roulette wheels comprising an operative period comprising an available period followed immediately by an unavailable period. This concatenation of the available period and the unavailable period may be repeated any number of times during the operative period. Said first 12, second 14, third 16, fourth 18, and fifth 20 automated roulette wheels are in digital communication with a server 22 comprising a control unit 24, a selecting member 26, and a memory unit 28. Said selecting member 26 is arranged to detect when said automated roulette wheels are in said available period or said unavailable period. A series of cameras 30 are in digital communication with the server 22 and are arranged to provide real-time video of said automated roulette wheels. A display unit 32, in further communication with the server 22, is arranged to receive said real-time video from the server 22 and display the real-time video to a user. A betting member 34 is provided, taking the form of a gaming table comprising all of the available betting options for the game of roulette.

The selecting member 26 is arranged to select one of the first 12, second 14, third 16, fourth 18 and fifth 20 automated roulette wheels that is in the available period. The selecting member 26 is further arranged to deselect the selected automated roulette wheel during its unavailable period. The unavailable period of the selected automated roulette wheel wherein the gaming system further comprises a betting member 34 arranged to accept betting information from a user for the selected physical random number generator; wherein one physical random number generator is selected at any one time.

FIG. 2 provides an isometric view of a portion of a system according to the first aspect of the present invention comprising a betting member 34 and a display unit 32. The betting member 34 takes the form of a gaming table having a raised horizontal surface 36 comprising a plurality of betting options 38, said betting options 38 encompassing the available betting options for a game of roulette. A substantially rectangular display member 32 is provided adjacent the table 34, arranged in a substantially vertical orientation perpendicular to the table 34, the lower edge of the substantially rectangular display member 32 abutting the horizontal surface of the table 34. The display member 32 comprises a screen providing a plurality of views, the views comprising a central view 40 arranged centrally with respect to the display member 32, and four auxiliary views 42 arranged in two rows of two views situated to the left of the central view 40, the central view 40 having an aspect ratio that is substantially larger than the four auxiliary views 42. The display member 32 is arranged to display an image of the selected automated roulette wheel using the central view 40, the image provided by the cameras 30.

FIG. 3 provides a time-lapse diagram of method according to the second aspect of the present invention, performed using a system according to the first aspect of the present invention. The diagram shows the start time 44 and end time 46 of each period for which the selected automated roulette wheel remains selected, denoted by the dashed lines. The available period 48, and the unavailable period 50, of the first 12, second 14, third 16, fourth 18, and fifth 20 automated roulette wheels are shown immediately following one another . The hollow vertical arrows represent the available periods of the selected automated roulette wheel which is selected by the selecting member 26. The horizontal dashed lines represent the end of the available period of the selected automated roulette wheel, the deselecting of the selected automated roulette wheel, and the selecting of a new selected automated roulette wheel by the selecting member. In the embodiment shown, the selecting member 26 selects the first automated roulette wheel 12 during the available period of said wheel. Upon completion of the available period of the first automated roulette wheel 12, the selecting member selects from the list of automated roulette wheel which are currently in the available period of said wheels.

The selecting member 26 selects the fourth automated roulette wheel 18. Upon completion of the available period of the fourth automated roulette wheel 18, the selecting member 26 selects the second automated roulette wheel 14, from the list of wheels in the available period. Following the completion of the available period of the second wheel 14, the selecting member proceeds to select the fifth automated roulette wheel 20. Following the completion of the available period of the fifth automated roulette wheel 20, the selecting member selects the third automated roulette wheel 16.
With reference to FIG. 4, a flow chart is shown outlining the steps of the example embodiment of a method according to the second aspect of the present invention shown in FIG. 3. The method comprises the steps of:
providing five automated roulette wheels, the roulette wheels having an operative period comprising an available period and an unavailable period 52;
providing a gaming table arranged to accept betting information from a user 54;
selecting one of the wheels, said selected wheel being in the available period 56;
accepting betting information on said selected wheel 58;
generating a win condition on said selected wheel 60;
transferring prize money to users having betting information matching the win condition 62;
deselecting said selected wheel immediately following the available period of said wheel, and immediately selecting another of the available wheels 64.

It will be appreciated that the above described embodiments are given by way of example only and that various modifications thereto may be made without departing from the scope of the invention as defined in the appended claims. For instance, in the example embodiments provided, the physical random number generators are automated roulette wheels. Additional embodiments will be appreciated wherein the physical random number generators are not automated. Additional embodiments will also be appreciated wherein the physical random number generator is not a roulette wheel, wherein the physical random number generator may be any physical random number generator suitable for accommodating an available period and an unavailable period.

In the example embodiments shown, five physical random number generators are provided. Additional embodiments will be appreciated wherein any number of physical random number generators, greater than or equal to two, are provided. In the embodiment shown, all of the physical random number generators are of the same general type. It will be appreciated that, in additional embodiments, there may be any number of combinations of physical random number generators of any type.

1. A gaming system comprising:
at least two physical random number generators each having an operative period comprising an available period and an unavailable period;
a selecting member arranged to select one of the at least two physical random number generators during the available period of the physical random number generator and further arranged to deselect the physical random number generator during the unavailable period of the physical random number generator;
wherein the gaming system further comprises a betting member arranged to accept betting information from a user for the selected physical random number generator, and wherein one of the at least two physical random number generators is selected at any one time.

2. The gaming system of claim 1,
wherein a random number is generated by the physical random number generators during the respective available period, and wherein the random number defines a win condition.

3. The gaming system of claim 2, wherein the available period comprises an exit period during which any of the betting information accepted from a user matching the win condition results in a win event.

4. The gaming system of claim 3, wherein the win event comprises a transfer of a prize to the user.

5. The gaming system of claim 1, wherein the unavailable period immediately follows the available period.

6. The gaming system of claim 5, wherein the selecting member is arranged to deselect the selected physical random number generator at a start of the unavailable period.

7. The gaming system of claim 6, wherein the selecting member is arranged to select one new physical random number generator of the at least two physical random number generators during an available period of the new physical random number generator immediately following the deselecting of a previously selected physical random number generator.

8. The gaming system of claim 1, further comprising a display member arranged to display an image of at least one of the physical random number generators.

9. The gaming system of claim 8, wherein the display member is arranged to display an image of all of the physical random number generators.

10. The gaming system of claim 8, wherein the display member is further arranged to indicate the selected physical random number generator to a user.

11. The gaming system of claim 10, wherein the display member is arranged to display an image of the selected physical random number generator without displaying an image of the deselected physical random number generator.

12. The gaming system of claim 8, wherein the image is provided by a camera.

13. The gaming system of claim 1, wherein the betting member comprises a gaming surface, a gaming table, a manual input device, or a touch screen.

14. The gaming system of claim 1, wherein the betting member is arranged to provide a view of and access to all of a plurality of available betting options for the selected physical random number generator to a user.

15. The gaming system of claim 1, wherein at least one of the physical random number generators is located remotely to the betting member.

16. The gaming system of claim 1, wherein the gaming system accepts the betting information from a user for only the selected physical random number generator at during the available period of the selected physical random number generator.

17. The gaming system of claim 1, wherein each physical random number generator comprises a roulette wheel; a dice shaker; a dice spinner; a number wheel; a money wheel; sic bo; cards; an electronic card shoe; a manual card shoe; a bingo machine; or a lottery machine.

18. The gaming system of claim 17, wherein at least one of the physical random number generators is automated.

19. The gaming system of claim 1, wherein the betting member comprises a memory arranged to store previously accepted betting information, and further prompts a user to submit the previously accepted betting information.

20. A method of increasing a number of betting opportunities in a time period, the method comprising:
providing at least two physical random number generators each arranged to generate a respective random number to define a win condition, the physical random number generators having an operative period comprising an available period and an unavailable period;
providing a betting member arranged to accept betting information from a user;
selecting one physical random number generator from the at least two physical random number generators, the selected physical random number generator being in the available period of the physical random number generator when selected;
accepting betting information on the selected physical random number generator;
deselecting the selected physical random number generators and
selecting another physical random number generator from the at least two random number generators, the selected physical random number generator being in the available period of the physical random number generator when selected.

21. The method of claim 20, wherein deselecting the selected physical random number generator comprises deselecting the selected physical random number generator following the available period of the selected physical random number generator.

22. The method of claim 20, further comprising generating, by the selected physical random number generator, a random number defining a win condition.

23. The method of claim 22, further comprising matching the betting information to the win condition resulting in a win event.

24. The method of claim 23, wherein the win event comprises a transfer of a prize to a user.
